(19) United States
(12) Patent Application Publication
(10) Pub. No.: US 2021/0273545 A1
(43) Pub. Date: Sep. 2, 2021

(54) Magnetic Force Reducer

(71) Applicant: Yi-Pin Liu, Taichung City (TW)

(72) Inventor: Yi-Pin Liu, Taichung City (TW)

(21) Appl. No.: 16/806,355

(22) Filed: Mar. 2, 2020

(51) Int. Cl. H02K 49/04

(52) U.S. Cl. CPC H02K 49/046; A62B 35/0093

(57) ABSTRACT

A magnetic force reducer is mounted on a holder having a belt and contains: a drive shaft, multiple rotators, and a magnetic conduct ring. The drive shaft is configured to rotate a rotatable disc, and the rotatable disc has multiple rotation segments and multiple first support portions. The multiple rotators are rotatably connected on two surfaces of the rotatable disc in parallel. A respective one rotator includes a swing arm rotatably connected with a respective one rotation segment and having a conductive rotation element and a second support portion. A resilient element is connected between the second support portion and a respective one first support portion of the rotatable disc. The magnetic conduct ring is fitted around the conductive rotation element of the respective one rotator to produce a magnetic field.

### FIELD OF THE INVENTION

The present invention relates to a magnetic force reducer which is capable of producing energy to stop vehicle effectively.

### BACKGROUND OF THE INVENTION

With reference to FIG. 1, a conventional magnetic force reducer A contains a drive shaft 40A configured to rotate a rotatable disc 50A, and the rotatable disc 50A having multiple rotation segments 21A and multiple first support portions 32A which are arranged on multiple positions of the rotatable disc 50A respectively;

multiple rotators 20A, a respective one rotator 20A including a swing arm 22A, wherein a first end of the swing arm 22A is rotatably connected with a rotation segment 21A of the respective one rotator 20A, and the swing arm 22A has a conductive rotation element 23A disposed on a second end thereof, the swing arm 22A further has a second support portion 31A defined on a predetermined position of the swing arm 22A, and a resilient element 30A is connected between the second support portion 31A and a respective one first support portion 32A of the rotatable disc 50A;

multiple magnetic conduct blocks 10A arranged around the conductive rotation element 23A of the respective one rotator 20A to produce a magnetic field, wherein the respective one rotator 20A is made of aluminum.

However, the respective one rotator 20A is lightweight, so it is not easy to rotate into the magnetic field. In other words, the conventional magnetic force reducer takes a long time to rotate quickly, thus causing unsafe operation. In addition, the conductive rotation element 23A of the respective one rotator 20A cannot be shielded completely, thus causing poor brake of vehicle.

The present invention has arisen to mitigate and/or obviate the afore-described disadvantages.

### SUMMARY OF THE INVENTION

One aspect of the present invention is to provide a magnetic force reducer which is capable of producing energy by using the multiple rotators and the rotatable disc so that the multiple rotators move to or over the magnetic conduct ring quickly, thus stopping vehicle effectively.

Another aspect of the present invention is to provide a magnetic force reducer by which when the respective rotator moves to the magnetic conduct ring, the conductive rotation element enters the magnetic conduct ring to maintain brake effect.

To obtain the above aspect, a magnetic force reducer provided by the present invention is mounted on a holder having a belt and contains: a drive shaft, multiple rotators, and a magnetic conduct ring.

The drive shaft is configured to rotate a rotatable disc, and the rotatable disc has multiple rotation segments and multiple first support portions which are arranged on multiple positions of the rotatable disc respectively.

The multiple rotators is rotatably connected on two surfaces of the rotatable disc in parallel, a respective one rotator includes a swing arm, wherein a first end of the swing arm is rotatably connected with a respective one rotation segment, and the swing arm has a conductive rotation element disposed on a second end thereof, the swing arm further has a second support portion defined on a predetermined position of the swing arm between the conductive rotation element and the respective one rotation segment, and a resilient element is connected between the second support portion and a respective one first support portion of the rotatable disc.

The magnetic conduct ring is fitted around the conductive rotation element of the respective one rotator to produce a magnetic field so that when the conductive rotation element rotates on the respective one rotator, the conductive rotation element moves to or over the magnetic conduct ring.

### BRIEF DESCRIPTION OF THE DRAWINGS

FIG. 1 is a cross sectional view of a conventional magnetic force reducer.

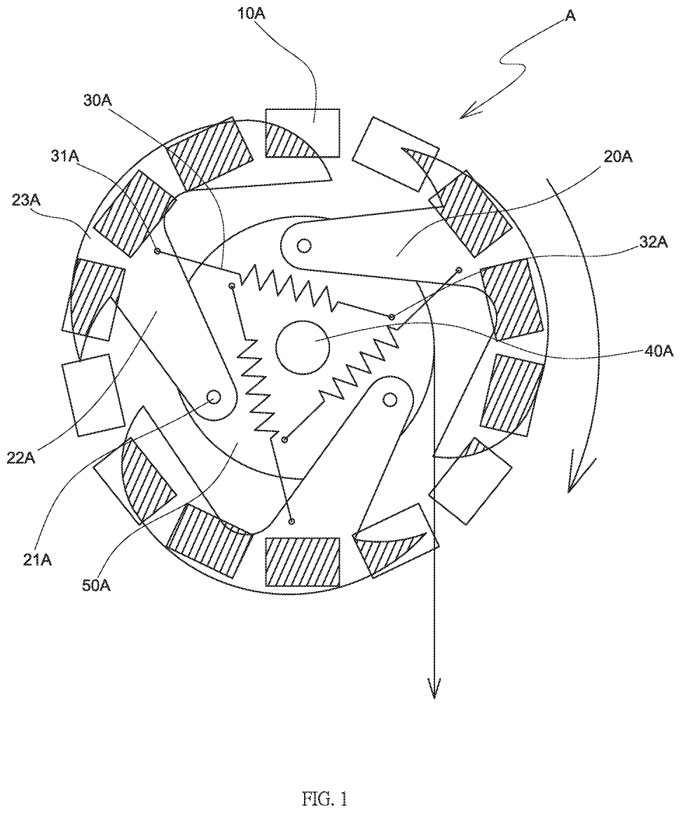

FIG. 2 is a perspective view showing the application of a magnetic force reducer according to a preferred embodiment of the present invention.

FIG. 3 is a perspective view showing the assembly of the magnetic force reducer according to the preferred embodiment of the present invention.

FIG. 4 is a perspective view showing the assembly of a part of the magnetic force reducer according to the preferred embodiment of the present invention.

FIG. 5 is a side plan view showing the operation of the magnetic force reducer according to the preferred embodiment of the present invention.

FIG. 6 is a cross sectional view showing the operation of the magnetic force reducer according to the preferred embodiment of the present invention.

### DETAILED DESCRIPTION OF THE PREFERRED EMBODIMENTS

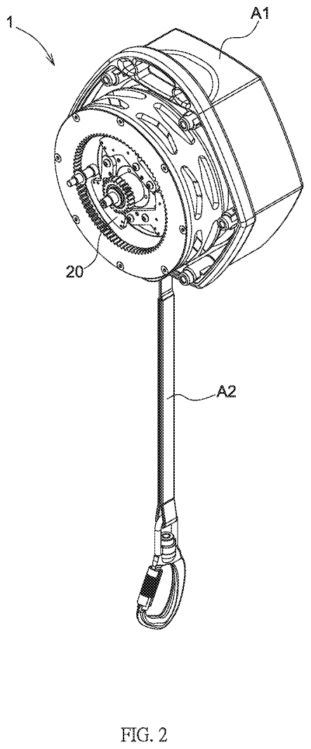

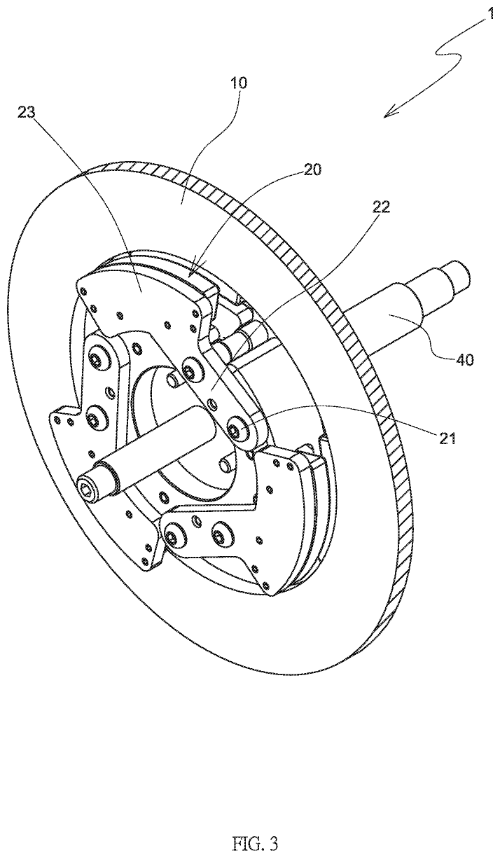

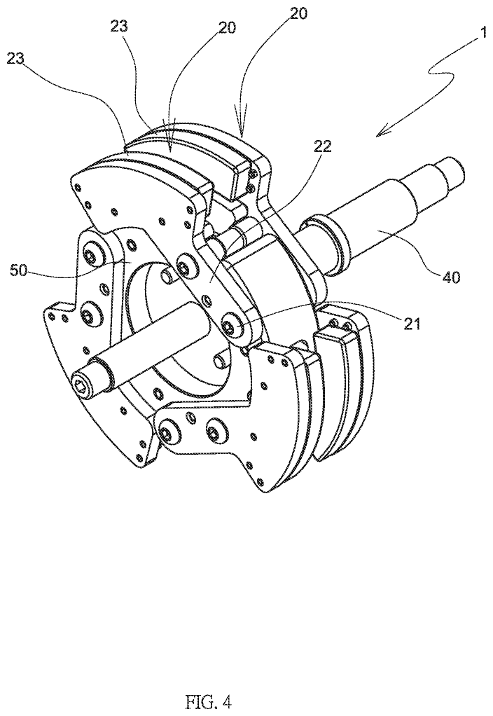

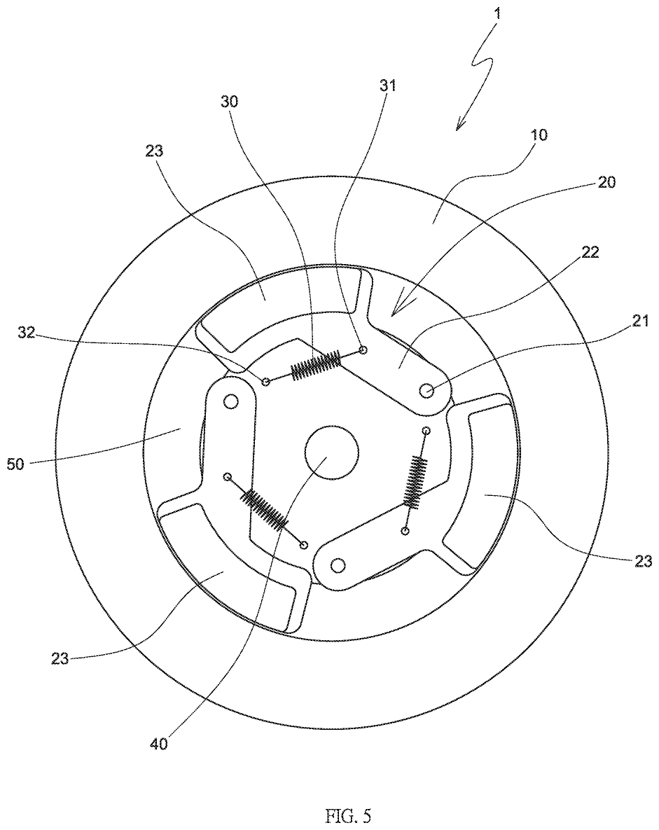

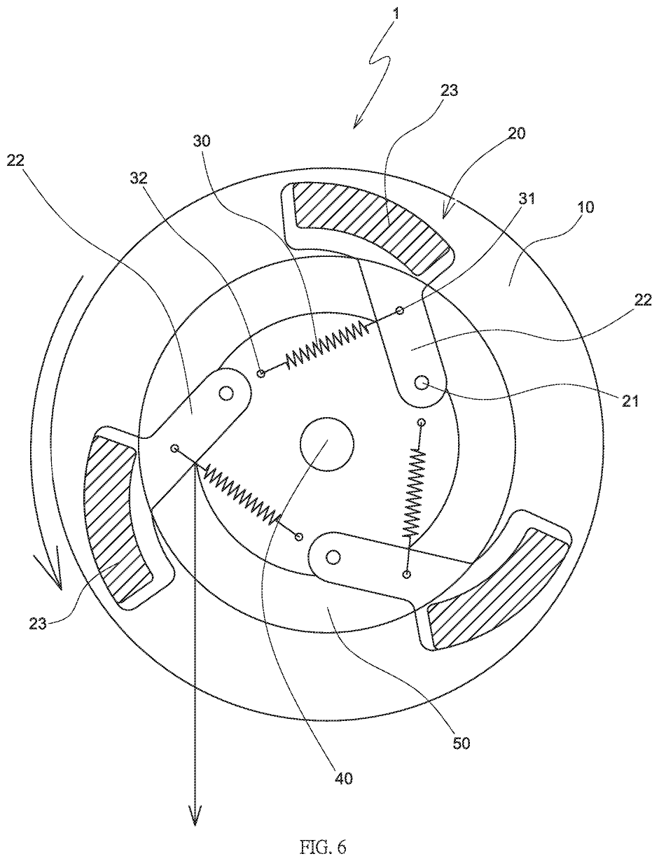

With reference to FIGS. 2 to 6, a magnetic force reducer 1 according to a preferred embodiment of the present invention is mounted on a holder A1 having a belt A2 and comprises:

a drive shaft 40 configured to rotate a rotatable disc 50, and the rotatable disc 50 having multiple rotation segments 21 and multiple first support portions 32 which are arranged on multiple positions of the rotatable disc 50 respectively;

multiple rotators 20 rotatably connected on two surfaces of the rotatable disc 50 in parallel, a respective one rotator 20 including a swing arm 22, wherein a first end of the swing arm 22 is rotatably connected with a respective one rotation segment 21, and the swing arm 22 has a conductive rotation element 23 disposed on a second end thereof, the swing arm 22 further has a second support portion 31 defined on a predetermined position of the swing arm 22 between the conductive rotation element 23 and the respective one rotation segment 21, and a resilient element 30 is connected between the second support portion 31 and a respective one first support portion 32 of the rotatable disc 50, wherein three rotators 20 are arranged on each of the two surfaces of the rotatable disc 50;

a magnetic conduct ring 10 fitted around the conductive rotation element 23 of the respective one rotator 20 to produce a magnetic field so that when the conductive rotation element 23 rotates on the respective one rotator 20, it moves to or over the magnetic conduct ring 10.

Thereby, the magnetic force reducer 1 is capable of producing energy by using the multiple rotators 20 and the rotatable disc 50 so that the multiple rotators 20 move to or over the magnetic conduct ring 10 quickly, thus stopping vehicle effectively. Preferably, when the respective rotator 20 moves to the magnetic conduct ring 10, the conductive rotation element 23 enters the magnetic conduct ring 10 to maintain braking effect.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A magnetic force reducer being mounted on a holder having a belt and comprising:
a drive shaft configured to rotate a rotatable disc, and the rotatable disc having multiple rotation segments and multiple first support portions which are arranged on multiple positions of the rotatable disc respectively;
multiple rotators rotatably connected on two surfaces of the rotatable disc in parallel, a respective one rotator including a swing arm, wherein a first end of the swing arm is rotatably connected with a respective one rotation segment, and the swing arm has a conductive rotation element disposed on a second end thereof, the swing arm further has a second support portion defined on a predetermined position of the swing arm between the conductive rotation element and the respective one rotation segment, and a resilient element is connected between the second support portion and a respective one first support portion of the rotatable disc;
a magnetic conduct ring fitted around the conductive rotation element of the respective one rotator to produce a magnetic field so that when the conductive rotation element rotates on the respective one rotator, the conductive rotation element moves to or over the magnetic conduct ring.

2. The magnetic force reducer as claimed in claim 1, wherein three rotators are arranged on each of the two surfaces of the rotatable disc.
